(19) United States
(12) Patent Application Publication
(10) Pub. No.: US 2010/0205046 A1
(43) Pub. Date: Aug. 12, 2010

(54) INTERACTIVE BUSINESS ENTERPRISE SYSTEM, METHOD AND COMPUTER PROGRAM PRODUCT FOR COLLECTING SELF-REPORTED EXPENDITURES AND REVENUE ON ZERO RELATIVE COST ACTIVITIES

(76) Inventor: Mitch Huhem, San Diego, CA (US)

Correspondence Address: Steven L. Rinehart, 1059 E. Millstream Way, Bountiful, UT, 84010, US

(21) Appl. No.: 12/369,751

(22) Filed: Feb. 12, 2009

(51) Int. Cl. G06Q 10/00; G06Q 20/00; G06Q 30/00

(52) U.S. Cl. 705/14.1; 705/39; 705/30; 705/26

(57) ABSTRACT

A method, computer program product and system are disclosed for collecting self-reported expenditures and revenue from members of an MLM business structure via an intendance server, and of subsequently rewarding third-parties with the revenue. The intendance server uniquely collects the self-reported expenditures, which expenditures are not necessarily monetary in nature. The overrides generated on self-reported expenditures are distributed throughout a hierarchical, multi-level marketing (MLM) business structure in accordance with a predetermined commission criteria.

### BACKGROUND OF THE INVENTION

1. Field of the Invention

This invention relates to a data processing system for collecting overrides paid on self-reported expenditures made in exchange for products and/or services of no-cost to a business enterprise.

2. Description of the Related Art

Multi-level marketing (MLM) hierarchical business structures (hereinafter “MLM structures”) are distinctive from other business structures in that they remunerate their members not just for income the members bring into the MLM structure, but also for the income that future members (“downstream members”) recruited by current members bring into the MLM structure, thereby allowing all members to profit directly not just from their own efforts, but from those of others.

MLM structures organize their members into hierarchical pay grades, or levels, and traditionally distribute commissions made on the sale of consumer products by trickling commissions up to members in higher levels, particularly those upstream members who were responsible for the incorporation of lower-level downstream members making sales.

Because of the quantity and magnitude of commissions necessarily paid within the MLM structure to upstream members, which commissions inhere to fixed transaction costs, MLM structures are more concerned than other business structures with the production costs of the consumer goods sold by members of the MLM structure. Essential to any MLM structure's success is its careful marketing of only select consumer products (including training programs in the MLM organization) whose production costs are low relative to other similarly priced retail items in the consumer economy. Examples of consumer products settled on by MLM structures in the past for their low production costs include cleaning supplies, natural fruit supplements, and vitamins.

Invariably, with time, successful MLM structure's methodologies and products are mimicked and incorporated by competing MLM structures. Subsequently, the profitability of the methodologies decreases with the increased competition as the search cost to consumers of the products decreases, followed by decreasing incentive for new members join the MLM structure. MLM structures are, therefore, constantly searching for new, more innovative products, with lower production costs, that have not yet been discovered or tested by competing MLM structures. Ideally, MLM structures would find and offer zero-cost, or negative production cost, consumer products, but such products are elusive in the free market. These problems inherent in traditional MLM structures have caused MLM structures to suffer decreasing, rather than increasing, efficiency as their market-share grows.

### SUMMARY OF THE INVENTION

From the foregoing discussion, it should be apparent that a need exists for an interactive business enterprise system, method, and computer program product for collecting self-reported expenditures and revenue on zero-cost items. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide an interactive business enterprise system, method, and computer program product for collecting self-reported expenditures and revenue on zero relative cost activities.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a commerce architecture according to the present invention, which architecture is designed to collect self-reported expenditures on activities with a zero-production cost or less to an MLM structure.

FIG. 2 is a block diagram illustrating one embodiment of an apparatus that collects self-reported expenditures on activities with a zero-production cost or less to an MLM structure in accordance with the present invention.

FIG. 3 is a flowchart illustrating methods of the present invention, including steps which may be performed online to collect self-reported expenditures on activities with a zero-production cost or less to an MLM structure in accordance with the present invention.

FIG. 4 is a diagram illustrating components of one embodiment of an interactive business enterprise system for collecting self-reported expenditures and revenue on zero relative cost activities in accordance with the present invention.

FIG. 5 is a Yourdon/DeMarco data flow diagram graphically modeling the processes of the present invention as those processes operate on money.

FIG. 6 is a diagram illustrating components of one embodiment of an interactive business enterprise system for collecting self-reported expenditures and revenue on zero relative cost activities in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

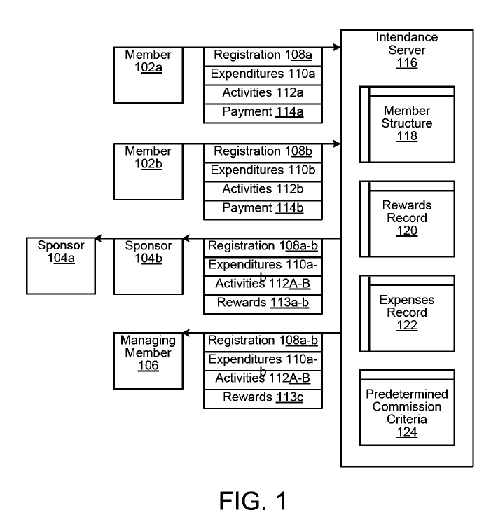

FIG. 1 is a diagram illustrating a commerce architecture 100 according to the present invention, which architecture is designed to collect self-reported expenditures on activities with a zero-production cost or less to an MLM structure. The commerce architecture 100 comprises a member 102a, a member 102b, a sponsor 104a, a sponsor 104b, a managing member 106, registration information 108a, registration information 108b, expenditures 110a, expenditures 110b, activities 112a, activities 112b, payment 114a, payment 114b, and an intendance server 116 which comprises a member structure 118, a rewards record 120, and expenses record 122.

For the purposes of this patent, the term “MLM structure” denotes a multi-level marketing business structure that incorporates its members in hierarchical pay grades, or levels, and remunerates commissions to members in higher levels for the sales of consumer products 106 realized by members in lower levels whom have been incorporated into the MLM structure as a result of the efforts of members in the higher levels. In some embodiments of the present invention, the MLM structure may alternatively or additionally comprise a religion or rehabilitation program. MLM structures are well-known to those of skill in the art and further described above.

The member 102a-b comprise individuals who have joined by the MLM structure and been “incorporated” after being sponsored into the MLM structure by preexisting members. The members 102a-b may comprise any person, company or organization that registers with the intendance server 116 after being sponsored by a sponsor 104a-b. For the purposes of this patent, the terms “incorporate” and “incorporation” denote the act of formally enrolling an individual or organization into an MLM structure such that the individual or organization is able to receives rewards, overrides, commissions, and/or remuneration on downstream and/or upstream sales realized as a result of the efforts of themselves and other members 102 within the MLM structure.

The commerce architecture 100 includes sponsors 104a-b. The sponsors 104a-b may comprise any individual, a company, or organization which recruits other individuals, companies, or organizations, or any combination of the above, into the MLM structure. In the shown embodiment, the sponsors 104a-b are individuals and members 102 previously incorporated into the MLM structure.

The commerce architecture 100 includes a managing member 106. The managing member 106 may comprise any individual, company, organization, or plurality of individuals, companies and organization, which recruit other individuals, companies, or organizations, or any combination of the above, into the MLM structure. The managing member 106 is primarily responsible for managing the intendance server 116 and day-to-day affairs of the MLM structure. In the shown embodiment, the managing member 106 is an individual who owns the MLM structure.

MLM information and data in transmitted back-and-forth between the intendance server 116, the members 102a-b, sponsors 104a-b, and the managing member 106. This MLM information comprises registration 108a-b, expenditures 110a-b, activities 112a-b, payments 114a-b, and rewards 113a-b. The MLM information may comprise computer readable files transmittable over a signal bearing medium like the Internet and storable on a computer readable storage. The MLM information may also comprise information about individuals and organizations not associated with the MLM structure but in the members 102a-b possession on computer readable storage. In typical embodiments, the MLM information is stored in member 102-side email databases by programs well-known to those of skill in the art, such Microsoft Outlook, Thunderbird, Yahoo! Mail, and the like.

The registration 108 information comprises contact information for the member 102a-b, including one or more of: age, address, gender, credit rating, email, telephone number, income, education, and purchasing practices.

The activities 112a-b are preferably made available to the member 102 at no cost to the MLM structure. The activities 112a-b take the place of consumer products in traditional MLM structures, and the MLM structure is designed to profit from them. An activity 112 may be as general as spending, and the members 102a-b may elect to voluntarily self-report all of their expenditures 110 to the MLM structure. For instance, members 102a-b may login to the intendance server 116 on a daily basis and self-report all of their credit-card spending. Members 102a-b may login nightly, weekly, monthly, or the like, to the intendance server 116 and report any combination of their cash, credit-card, checking, and other expenditures.

The expenditures 110a-b comprise the data actually reported by members 102a-b rather than the type of activity 112 the expenditures are being reported for. Per above, the expenditures 110a-b may comprise monetary expenditures by members 102a-b, but may also comprise expenditures of time spent engaged in other personal activities, including time spent loving a spouse or significant other, hunting, fishing, hiking, running, exercising, dieting, taking vitamins, taking nutritional supplements, taking protein supplements, taking prescriptions, weight-lifting, doing push ups, playing chess, time spent playing with children, time spent at religious services, etcetera, or even time spent engaged in unproductive or self-destructive personal activities from which the members 102a-b wish to abstain, such as drinking or gambling.

The expenditures 110a-b may additionally or alternatively comprise reports of time spent abstaining from certain other personal activities, preferably self-destructive activities, including drinking, smoking, taking drugs, gambling, sex, looking at pornography, smoking, watching television, playing video games, eating sugar, ingesting unhealthy foods, sleeping, driving, working, surfing the Internet, talking on the phone, drafting patents, crying, masochistic behaviors, playing, and the like.

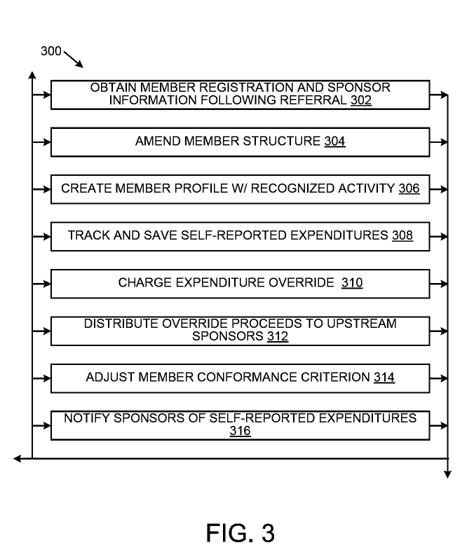

Member 102a-b may have many incentives to self-report, including religious reasons in the case that self-reporting a certain activity is required by a religious body with whom the members 102a-b affiliate. Members may be motivated to self-report by rehabilitations programs with which they are involved. Members 102a-b may self report to maintain their membership in the MLM structure, or to reach higher-and-higher levels of conformance with the dictates of an MLM structures, other business structures, religions, rehabilitation programs, and the like (conformance is substantially described below in relation to FIG. 3) such that they are entitled to increased rewards 113 and/or payments 114 from the MLM structure.

The MLM structure charges members 102a-b overrides, or payments 114, on the expenditures 110 self-reported by members 102a-b. The payments 114 are compulsory within the MLM structure on self-reported expenditures 110, which expenditures 110 themselves are not compulsory. Payments 114 are made via electronic means well-known to those of skill in the art, including PayPal®, credit-card credits, direct bank deposits, eCheck, and the like. The amount of the payment may be determined in accordance with a predetermined payment criteria set by the managing member 106.

The commerce architecture 100 includes an intendance server 116. In the shown embodiment, the intendance server 116 comprises a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the present invention, the intendance server 116 may route information to any other DPD or device in communication with the intendance server 116, internal or external, and the intendance server 116 may comprise those device(s) for the purposes of interpreting the present invention. In some embodiments, the intendance server 116 is configured to interact with members 104a-b through a graphical user interface (GUI) coupled to an external DPD or the intendance server 116 itself. The intendance server 116 may comprise a relational database management system (RDBMS) or a database management system (DBMS), such as Oracle, DB2, Firebird, SQL, or other DBMSs as well-known to those of skill in the art.

In this embodiment, the intendance server 116 is managed by an MLM structure and collects self-reported expenditures from MLM members 102a-b, along with registration and contact information. In some embodiments, the intendance server 116 communicates with MLM members 102a-b over a distributed network. In various embodiments, a plurality of MLM members 102a-b incorporated into an MLM structure may be in logical communication with the intendance server 116 through a networked environment, such as local area network (LAN) or wide area network (WAN), or the Internet.

In the shown commerce architecture 100, the intendance server 116 comprises a member structure 118, which, in the shown embodiment, is a computer readable file written in computer readable storage accessible by the intendance server 116, usually a relational computer database. The member structure 118 preferably comprises a structured computer-readable file, but may also comprise a book, audio recording, video, digital image, or the like. The member structure 118 stores relational information between members 102a-b and sponsors 104a-b, including which sponsor 104 recruited, or sponsored, which member(s) 102a-b. The member structure 118 stores the type of activity 112 that the intendance server 116 will track for each member 102a-b. The member structure 118 further stores registration 108a-b.

In the shown embodiment, the commerce architecture 100 comprises a rewards record 120, which is a computer readable file written in computer readable storage accessible by the intendance server 116. The rewards record 120 keeps a running tally of all rewards 113, commissions, remuneration, overrides, and consideration (“rewards 113”) paid by the MLM structure to MLM members 102a-b and/or MLM sponsors 104a-b, usually in a database.

The rewards 113 usually comprise a portion of the overrides paid by members 102a-b. The rewards 113 may also comprise reward points given by the MLM structure to its members 102a-b, its sponsors 104a-b, and its managing member 106.

In the shown embodiment, the commerce architecture 100 comprises an expenses record 122, which is a computer readable file written in computer readable storage accessible by the intendance server 116. The expenses record 122 keeps a running tally of all expenses self-reported by individual MLM members 102a-b, usually in a database.

In various embodiments, the maintenance server 102 may make available sales information to customers 110 and/or solicitors 108. In various embodiments the sales information may comprise commissions paid, or to be paid, to the customer(s) 110 on sales realized as a result of the solicitation of one or more contacts 114a-c.

In still further embodiments, the intendance server 116 may automatically pay rewards 113 to members 102a-b and sponsors 104a-b incorporated into the MLM structure via means well-known to those of skill in the art, including PayPal®, credit-card credits, direct bank deposits, eCheck, and the like. Rewards 113 paid to sponsors 104a-b may be paid in accordance with a predetermined commission criteria 124.

The rewards 113 may comprise any intangible possession of value, including video, audio, digit text files, or the like. The rewards 113 may comprise reward points given by the MLM structures to members 102a-b and/or sponsors 104a-b. The reward point may be strictly nontangible in nature, and may be redeemed for other tangible or nontangible prizes, such as consumer goods or air travel. In the preferred embodiment, the rewards 113 are cash payments derived from revenue generated on payments 114 by members 102a-b.

The predetermined commission criteria 124 comprises a distribution plan pursuant to which rewards 113 are distributed within the MLM structure. The predetermined commission criteria 124 is a computer readable file written in computer readable storage accessible by the intendance server 116. In some embodiments, the predetermined commission criteria 124 is dynamic, and optimized automatically through analysis of historical MLM revenue and expenditures data to maximize profits to the MLM structure and/or sponsors 104a-b. In other embodiments, the predetermined commission criteria 124 is static, and its directives set by the managing member 106.

In other embodiments, the predetermined commission criteria 124 incorporates some element of randomness to its distribution plain. In certain embodiments of the present invention, members 102a-b are awarded reward points for self-reporting which reward points increase the member's 102a-b chances of getting extra-pro rata distributions from the MLM structure in random assignments.

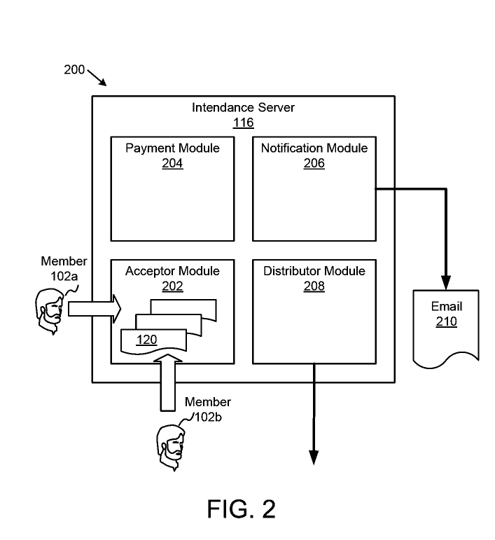

Referring now to FIG. 2, a block diagram illustrating one embodiment of an apparatus 200 that collects self-reported expenditures on activities with a zero-production cost or less to an MLM structure in accordance with the present invention. The apparatus 200 includes an acceptor module 202, a payment module 204, a notification module 206, and a distributor module 208. The apparatus 200 also comprises a database server comprising a memory device and configured to store executable and operational data.

The acceptor module 202, in the shown embodiment, is configured to accept one or more self-reported expenditures 110 from MLM members 102a-b on items or activities that do not have a positive production cost(s) to the MLM structure. The acceptor modules is further configured to store expenditures 110 reported by members 102a-b in the expenses record 122. The acceptor module 202 may comprise the hardware, software and/or firmware necessary to read block storage or content-addressable storage as will be recognizable to those of skill in the art. In some embodiments, the acceptor module 202 accepts and stores all information transmitted to the intendance server 116 by members 102a-b, including the contact information substantially described above.

In some embodiments of the present invention, the apparatus 200 includes an accessor module (not shown) for accessing the member structure 118. The accessor module may comprise the hardware, software and/or firmware necessary to read block storage or content-addressable storage as will be recognizable to those of skill in the art.

In some embodiments of the present invention, the apparatus 200 includes a storage module (not shown). The storage module stores the MLM information in persistent storage to which the intendance server 116 has access. The storage module may comprise a peripheral device which is internal or external to the intendance server 116, such as a disk-drive.

In some embodiments of the present invention, the apparatus 200 includes a charger module (not shown). The charger module bills members 102a-b an amount of money determined in accordance with the predetermined commission criteria 124 substantially described above.

The payment module 204 is configured to accept electronic payments of money in amounts specified by the charger module and/or the predetermined commission criteria 124 using means well-known to those of skill in the art as substantially described above in relation to FIG. 1.

The notification module 206, in the shown embodiment, notifies sponsors 104a-b that members 102a-b have paid overrides on self-reported expenditures. The notification module 206 may transmit notices and MLM information to sponsors 104a-b via email 210 using variations of the Simple Mail Transfer Protocol (SMTP), Internet Message Access Protocol (IMAP), Post Office Protocol (POP), or other protocols well-known to those of skill in the art.

The distributor module 208 distributes money to sponsors 104a-b and the managing member 106 via means well-known to those of skill in the art.

In some embodiments of the present invention, the apparatus 200 includes a rewarder module (not shown). The rewarder module distributes non-monetary rewards 113 to members 102a-b and/or sponsors 104a-b in accordance with a predetermined commission criteria. The rewarder module is configured to operate as substantially described above in relation to FIG. 1.

In some embodiments of the present invention, the apparatus 200 includes an incorporation module (not shown). The incorporation module incorporates new members 102a-b into the MLM structure in accordance with a predetermined commission criteria. The incorporation module is configured to adopt the incorporating functionality substantially described above in relation to FIG. 1. In various embodiments, the incorporation module creates a logical pay grade, or level, in which the incorporation module registers, or recognizes, members 102a-b for later use in remuneration, rewarding, and MLM structuring purposes.

Referring now to FIG. 3, a flowchart illustrating a method 300 of the present invention, including steps which may be performed online to collect self-reported expenditures on activities with a zero-production cost or less to an MLM structure in accordance with the present invention.

The method 300 begins with obtaining 302 member registration and sponsor information, including MLM information, from members 102 and/or sponsors 104, usually via the intendance server 116 substantially described above.

Next, the method 300 progresses with amending 304 the member structure 118 to incorporate the members 102 reflected in the information obtained at 302. The MLM information is stored in persistent storage on the intendance server 116 where it can be eventually or immediately transmitted to, or accessed by, the managing member 106.

Subsequently, the method 400 continues to creating 306 a member profile for the member 102 which includes the type of activity 112 for which the member 102 will be reporting expenditures 110.

The method 400 continues by charging 310 the member 102 overrides on self-reported expenditures 110 and accepting payment 114 of the overrides.

The method 400 continues by distributing 312 the payments 114 made at 310 on self-reported expenditures 110.

The method 400 continues by charging 310 the member 102 overrides on self-reported expenditures 110.

The method continues 400 by adjusting a member conformance criterion. The conformance criterion is a datatype unique to each member 102 in the MLM structure denoting a level of self-reporting which a specific member 102 has attained. The MLM structure may recognize many levels of self-reporting. Members 102, in some embodiments, reach increasingly higher levels of conformance as they increasingly, or more frequently, self-report. The conformance criterion may be a factor used by the predetermined commission criteria to calculate the amount of payments 114 made to sponsors 104. The conformance criterion may preclude sponsors 104 and/or members 102 altogether from receiving rewards 113 or payments 114 from the MLM structure.

Finally, the method 300 notifies 316 sponsors 104 of self-reported expenditures 110 made by members 102.

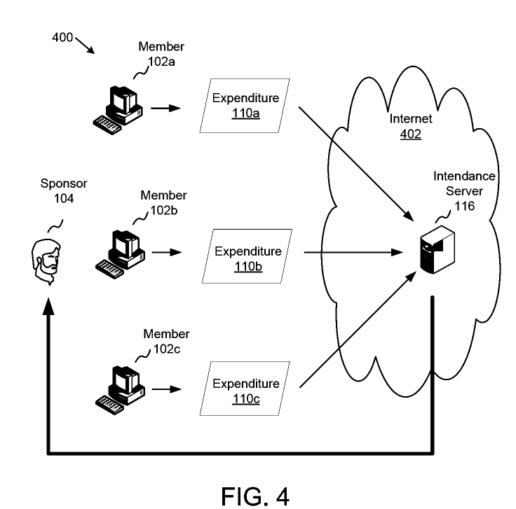

FIG. 4 is a diagram illustrating components of one embodiment of an interactive business enterprise system 400 for collecting self-reported expenditures and revenue on zero relative cost activities in accordance with the present invention. The interactive business enterprise system 400 illustrated in FIG. 4 comprises members 102a-c, expenditures 110a-c, an intendance server 116, a sponsor 104, and an Internet 402.

The members 102a-c, expenditures 110a-c, an intendance server 116, and sponsor 104 are each substantially described above in relation to FIGS. 1-3.

The shown embodiment, the members 102a-c comprise DPDs which automatically self-report after being programmed to do by individuals.

The system 400 includes an Internet 402, well-known to those of skill in the art. The Internet 402 may comprise any collection of interconnected computers and computer networks linked by ethernet cables, wireless connections, and the like, such as the world-wide-web.

The interactive business enterprise system 400 corresponds generally to other systems, methods, apparatii and computer program products outlined in the present invention, but further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

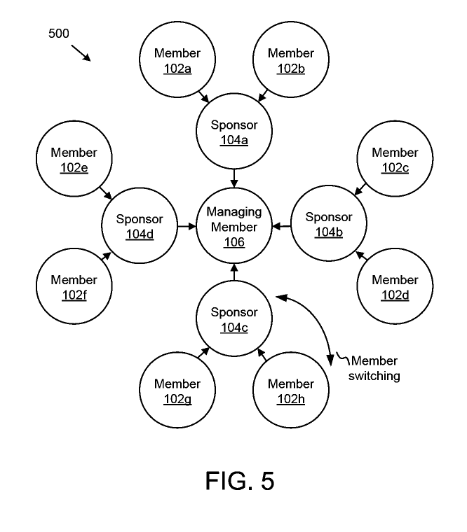

Referring now to FIG. 5, a Yourdon/DeMarco data flow diagram graphically modeling the processes 500 of the present invention as the processes 500 operate on money. The processes 500 operates to transfer money from members 102a-h, shown on the outside of the circle forming FIG. 5. Money flows to the inside of the circle, first to sponsors 104a-d, and subsequently to the managing member 106.

The circle grows as members 102a-h recruit new members who are incorporated into the MLM structure, and as current members 102a-h become sponsors 104.

Each of the members 104a-h in the MLM structure are assigned a unique identifier saved in the member structure 118. As shown in by FIG. 5, there is unidirectional, pyramid-like structure to the member structure 118, and hence the member structure 118 may comprise a modified B-tree data structure. Modified B-tree graphs may be graphically recreated for the managing member 106, sponsors 104, and/or members 102 showing parent and child relationships within the structure, useful to the predetermined commission criteria in identifying MLM pay grades, or lever, and useful in calculating commissions. All new members 102 to the MLM structure become “children” to at least one previously incorporated member 102 within the MLM structure.

In some embodiments of the present invention, when a specific member's 102 conformance criterion reaches a predetermined level relative to their sponsor 104's conformance criterion (or “parent” in the B-tree), said member 102 switches positions with said sponsor 104 within the member structure 118 and the modified B-tree graphically represented in FIG. 5, thus provided increased incentive to sponsors 104 to self-report (to prevent from being demoted, or rotated down, in the MLM structure). The position switching, rotating down, or member switching (shown), in some embodiments, may occur when the conformance criterion of a member 102 exceeds the conformance criterion of a sponsor 104 by an amount predetermined by the managing member 106.

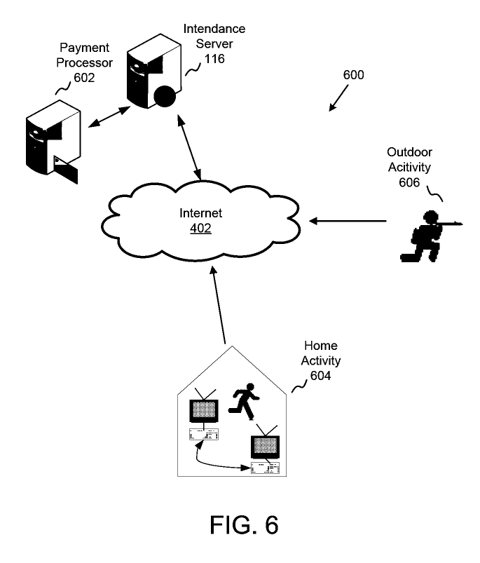

FIG. 6 is a diagram illustrating components of one embodiment of an interactive business enterprise system 600 for collecting self-reported expenditures and revenue on zero relative cost activities in accordance with the present invention. FIG. 6 illustrates one embodiment of a system 600 for processing data by MLM structures in accordance with the present invention. FIG. 6 illustrates that certain automated, or non-automated, functions of the MLM structure may be performed concurrently, or non-sequentially. For instance, a member 102 performs an outdoor activity 606 like hunting, then self-reports over the Internet 402 the length of his activities, all while another member 102 engages in a home activity 604 like running on a treadmill, and thereafter self-reports over the Internet 402 to a global intendance server 116, which distributes money collected from members 102 on activities 604, 606 to a payment processor 602.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for collecting self-reported expenditures and revenue on zero-cost items, the operations of the computer program product comprising:
incorporating an MLM member into an MLM structure who is sponsored by an MLM sponsor;
electronically accessing identifying information of the MLM member via a computer network, said contact information accessible only through a grant of permission of from the MLM structure, said contact information structured in one or more computer readable files and comprising all of name, email, sponsor, and an activity identifier identifying one or more self-reportable activities in which MLM member is engaged;
accepting one or more self-reported expenditures from the MLM member on activities that do not have a positive production cost to the MLM structure, and storing the self-reported expenditures in computer readable memory;
charging the MLM member an override on self-reported expenditures;
accepting electronic payment of the override;
distributing the electronic payment to one or more sponsors;
rewarding the MLM member for self-reporting and making the electronic payment; and
transmitting notice of the self-reported expenditures and electronic payment to one or more sponsors.

2. The computer program product of claim 1, wherein the one or more sponsors are also MLM members who have self-reported expenditures to the MLM structure.

3. The computer program product of claim 1, wherein the one or more sponsors are remunerated in accordance with a predetermined commission criteria.

4. The computer program product of claim 1, further comprising remunerating a managing member of the MLM structure with a portion of the electronic payment.

5. The computer program product of Claim I, wherein the contact information is stored in a B-tree data structure on a computer readable storage device in contact the with computer program product.

6. The computer program product of claim 5, wherein the MLM member switches places with the MLM sponsor within the B-tree data structure and the MLM structure in response to a conformance criterion associated with the MLM member exceeding a conformance criterion associated with the MLM sponsor by a predetermined magnitude.

7. The computer program product of claim 7, wherein the electronic payment is made over an Internet using one or more of: PayPal®, eCheck, credit-card, and debit card.

8. The computer program product of claim 7, wherein the electronic payment is made using non-tangible reward points given to the MLM member by the MLM structure.

9. An apparatus configured to collect self-reported expenditures and revenue on zero-cost items, the apparatus comprising:
A database server comprising a processor and a memory device, the database server configured to store executable and operational data, the memory device comprising:
an incorporation module configured to incorporate an MLM member into an MLM structure who is sponsored by an MLM sponsor;
an accessor module configured to electronically access identifying information of the MLM member via a computer network, said contact information accessible only through a grant of permission of from the MLM structure, said contact information structured in one or more computer readable files and comprising all of name, email, sponsor, and an activity identifier identifying one or more self-reportable activities in which MLM member is engaged;
an acceptor module configured to accept one or more self-reported expenditures from the MLM member on activities that do not have a positive production cost to the MLM structure, and storing the self-reported expenditures in computer readable memory;
a charger module configured to charge the MLM member an override on self-reported expenditures;
a payment module configured to accept electronic payment of the override;
a distributor module configured to distribute the electronic payment to one or more sponsors;
a rewarder module configured to reward the MLM member for self-reporting and making the electronic payment; and
a transmitter module configured to transmit notice of the self-reported expenditures and electronic payment to one or more sponsors.

10. The apparatus of claim 9, further comprising a communication module configured to email third-parties with MLM promotional information.

11. The apparatus of claim 9, wherein the one or more sponsors are also MLM members who have self-reported expenditures to the MLM structure.

12. The apparatus of claim 9, wherein the one or more sponsors are remunerated in accordance with a predetermined commission criteria.

13. The apparatus of claim 9, further comprising a remuneration module configured to remunerate a managing member of the MLM structure with a portion of the electronic payment.

14. The apparatus of claim 9, wherein the contact information is stored in a B-tree data structure on a computer readable storage device in contact the with computer program product.

15. The apparatus of claim 9, wherein the electronic payment is made using non-tangible reward points given to the MLM member by the MLM structure.

16. A system to automatically collect self-reported expenditures and revenue on zero-cost items, the system comprising:
a processor;
a data storage means for storing data;
an intendance server to store, transfer and deliver data over an Internet, the intendance server comprising:
an incorporation module configured to incorporate an MLM member into an MLM structure who is sponsored by an MLM sponsor;
an accessor module configured to electronically access identifying information of the MLM member via a computer network, said contact information accessible only through a grant of permission of from the MLM structure, said contact information structured in one or more computer readable files and comprising all of name, email, sponsor, and an activity identifier identifying one or more self-reportable activities in which MLM member is engaged;
an acceptor module configured to:
accept one or more self-reported expenditures from the MLM member on activities that do not have a positive production cost to the MLM structure;
storing the self-reported expenditures in computer readable memory; and
adjust a conformance criterion unique to the MLM member;
a charger module configured to charge the MLM member an override on self-reported expenditures;
a payment module configured to accept electronic payment of the override;
a distributor module configured to distribute the electronic payment to one or more sponsors;
a rewarder module configured to reward the MLM member for self-reporting and making the electronic payment; and
a transmitter module configured to transmit notice of the self-reported expenditures and electronic payment to one or more sponsors.

17. The system of claim 16, wherein the one or more sponsors are remunerated in accordance with a predetermined commission criteria.

18. The system of claim 16, wherein the maintenance server allows the third-party contacts to place orders for a consumer product online via the Internet.

19. The system of claim 16, wherein the contact information is stored in a B-tree data structure on a computer readable storage device in contact the with computer program product.

20. The system of claim 16, wherein the electronic payment is made using non-tangible reward points given to the MLM member by the MLM structure.
